(19) United States
(12) Patent Application Publication
(10) Pub. No.: US 2004/0225486 A1
(43) Pub. Date: Nov. 11, 2004

(54) System for generating a resultant model for a power system

(76) Inventors: Vance Condary Mullis III, Alpharetta, GA (US); Nader Shariat Moharari, Marietta, GA (US)

Correspondence Address: LAVA GROUP LAW BY SMITH & FROHWEIN, LLC, P.O. BOX 88148, ATLANTA, GA, 30356, US

(21) Appl. No.: 10/434,026

(22) Filed: May 8, 2003

(51) Int. Cl. G06F 17/50

(52) U.S. Cl. 703/18

(57) ABSTRACT

A system for generating a resultant model for a particular generation or transmission power system is described, illustrated and claimed. The system involves a new and novel method that combines scenarios and their probabilities to estimate the areas of possible congestion, the expected values of congestion contracts, locational marginal prices, and scenario specific generation and transmission expansion plans as well as other relevant outcomes. One embodiment of the present invention is a model that develops multiple generation and transmission scenarios.

### TECHNICAL FIELD

The present invention relates the electric power generation and transmission industry and, more particularly, to a model to predict the effect of regulatory changes, generation and transmission expansions, and other factors on the electric power industry and predicting the likelihood of transmission congestion and cost associated with that congestion in various regions affected by such changes.

### BACKGROUND OF THE INVENTION

One of the most technological advancements that occurred during the 20^{th} century was the widespread use of electric power. As power distribution moved from locally based generators to a massive, intertwined and interconnected transmission system that spanned the entire United States continent, industrial plants were liberated from the constraints of having to be established in close proximity to power sources. During this time, electric power migrated from a luxury, to necessity and today, is currently traded as a commodity on the open market.

The generation and transmission of electric have been highly influenced by state and federal environmental laws. Today in some parts of the US and the world, the power industry is being migrated to a deregulated industry in which individual competitors are struggling to capture or expand their market share. Because state and federal environmental laws in the US influence the manner in which electrical power is generated and transmitted, these regulations also have a great influence on the cost associated with providing electrical power. Presently, power generation plants are operating under the guidelines set forth in the Clean Air Act enacted in 1990.

The United States Environmental Protection Agency (the “EPA”) has issued a set of rules that require large reductions in nitrogen oxide (NOx) emissions in most eastern states. Additional legislation and rules are proposed and expected, and there is considerable uncertainty concerning the parameters of the next wave of regulations. The requirements are focused on reductions from electric power plants and large industrial boilers. Many states are required to reduce overall nitrogen oxide emissions starting in 2003 with others following in 2004. Other regulations that are directed towards limiting other emissions are also in various stages. The other emissions that are the subject of regulation include SO₂ and mercury. Beyond air quality, there are other environmental regulations that affect the way generators run their power plants such as but not limited to water and waste control. All of these regulations will have a dramatic effect on the way power companies generate electric power, and ultimately on the transmission of that power.

Today, there are several sources for the generation of electric power. Some of these sources include coal, hydro, nuclear and natural gas based generators. Throughout the United States, and even within electric power generation plants, any of a variety of these fuel types may be employed. Each generator type has its own parametric values of cost per energy unit, reliability, and emissions. One of the primary goals of a power generation plant is to generate its supply of electric power in the most cost effective and profitable manner without violating present environmental standards or exceeding transmission capabilities within the transmission system.

As more stringent environmental regulations come into effect, the power companies will be forced to restructure the operation of their plants to generate power in the most cost effective manner under the new environmental standards. This restructuring will have a dramatic effect on the transmission of power within these regions. The power generation capability of some plants may be greatly reduced due to the inability to meet the new environmental standards in a cost effective and profitable manner. On the other hand, other plants may adopt new technology enabling them to experience a significant increase in the ability to produce power.

FIG. 1 is a stack diagram illustrating how new environmental regulations may change the generation and transmission of power from the supply stack. The first stack 100 illustrates the firing order for power generators and or plants A-G at a first state. The blocks in the first stack 100 are arranged in the order of cost effectiveness or, the dollars per megawatt-hour that they cost to run. For instance, block A may be a coal based generator and block G may be a power plant predominantly comprised of natural gas generators. For any particular point in time, a load demand 110 identifies how much electrical power the stack needs to provide. Once new regulations are instituted, it may be necessary to rearrange the firing order such as in the configuration shown in the second stack 120 to have the most economic configuration. In this simplified example, power source A moves from the first firing position to the last. As a further example, power source A could be a coal-based generator—a very inexpensive source of energy but one with greater emissions than other sources. A new environmental regulation may result in requiring significant and costly changes to the power source A to bring it into compliance with the regulations. Thus, under the new regulations the power source A may decide not to investment in the required scrubbers or SCRs (Selective Catalytic Reduction, a type of NOx reduction filter) but instead reduce operating time in order to comply.

As the generation capabilities of plants shift, it is anticipated that the present transmission system may not be sufficient to meet the transmission demands. Many experts would argue it is less than optimal now. For instance, a predominately coal-based power plant that operates at 70-90% capacity under the present environmental standards may be forced to operate at a much lower capacity under a new set of environmental standards. The transmission capacity previously utilized by this power plant will be underutilized after the enactment of the new environmental standards. However, the power demand would remain virtually the same. As a result, one or more other power plants will be required to operate at higher capacity in order for the power demand to be met. If the transmission capacity available to these one or more other power plants was already operating at the maximum transmission level, then transmission congestion will occur until the transmission system can be upgraded. Thus, an enactment of new environmental regulations may result in creating congestion in the transmission system.

To maintain competitiveness within the industry, it is beneficial for an independent power producer to be able to predict the effect that new environmental regulations will have on their ability to generate electrical power. Regulated utilities must make the same predictions in their fiduciary obligation to minimize the cost of electricity to the customers. In addition, there is a need for a mechanism to be able to predict the effect that compliance with these new regulations will have on the transmission of this power. Unfortunately, the regulations that will ultimately be enacted depend on many factors and it would be impossible to predict the actual regulations that will be imposed on the industry. This uncertainty makes it extremely difficult for a power company to get an early start on meeting the environmental standards. Thus, there is a need for a mechanism that can predict the effect that a range of regulatory requirements and generation and transmission infrastructure modifications will have on the electric power industry.

Two categories of models have been developed by the industry to help meet these needs. The first model is utilized to predict the effect of regulatory changes and generation expansions on the dispatch or firing order of generators. This model will be referred to as the Optimum Generation Expansion Plan (OGEP) model. The second model is used to determine an optimal power flow analysis. This model will be referred to as the Optimal Power Flow Analysis (OPF) model. OGEP is a long-term (multi-year) generation analyzer allowing generation additions. OPF is a short-term (hours or less) integrated transmission and generation analyzer that does not allow generation or transmission additions.

Optimum Generation Expansion Plan (OGEP)

FIG. 2 is a conceptual diagram of an Optimum Generation Expansion Plan (OGEP) model. The OGEP 200 accepts various input parameters and based on these input parameters, predicts sundry variables that are involved in establishing dispatch ordering of generators. More specifically, the OGEP synthesizes wholesale electric markets, environmental regulations and fuel markets into one integrated framework. OGEP is a computer-based programming model with detailed representation of every major electric boiler and generator. The number of electric boilers and generators may be limited to a specific study region. The model is used to determine the least cost means of meeting electric generation energy and capacity requirements, while complying the specified environmental regulations. The model also simulates coal and natural gas production, transportation and consumption. In its most thorough implementation, the OGEP simulates the full range of options including:

emissions control retrofits such as scrubbing, selective catalytic reduction (SCR),

selective non-catalytic reduction (SNCR), gas reburning;

purchase of allowances or credits;

other environmental effects and scenarios;

multiple fuel costs;

load growth scenarios;

repowering;

unit operating costs;

additions of generators;

retirement of generators; and

dispatch changes.

The inputs to the OGEP 200 include the environmental legislation scenarios to be simulated 210, fuel supply and transportation costs 220, environmental compliance technology cost and performance 230, electric market conditions 240, and generation expansion options 250. The environmental legislation scenarios 210 include the current policies that are in effect, as well as an array of anticipated changes. The fuel supply and transportation costs 220 include a variety of parameters such as the demand for various fuels, the demand for various types of energy, and the supply, including the cost of recovery and delivery, of various fuels such as coal and gas. The environmental compliance technology costs 230 include the existing technologies and the known costs associated with them. The electric market conditions 240 include an analysis of new technologies that are in development and that may be introduced to the industry in the near future and load growth scenarios. Finally, the generation expansion options 250 include the addition and retirement of generating facilities of various fuel types.

The outputs 260 of the OGEP 200 include unit operating costs, generation expansion units and the location on the grid, optimal compliance plans for individual generation units, allowance prices, compliance costs, and electric prices. More specifically, the OGEP 200 provides information related to capacity additions that may be required. This includes identifying generators that must be added, the types of generators that should be added or shut down (or simply reduced usage). The OGEP 200 will also provide an estimate of the cost to produce electrical power and the costs of fuel used to create the electrical power. The OGEP 200 will predict the prices for allowances or emission credits that can be purchased by a power company, the level of environmental emissions that can be expected from a specific configuration of dispatch ordering, and what retrofit decisions can be made (e.g., strap on technology) to help bring a power plant into compliance. Finally, the OGEP 200 provides a least cost solution to comply with the array of environmental regulations that were input into the OGEP 200.

The OGEP is a useful tool for power companies to utilize in determining the least cost configurations to operate their plants under a particular set of regulatory requirements. However, this technique lacks the ability to include the transmission expansion options and constraint data. Additionally, it lacks the inclusion of expected locational marginal prices and shift factors for all hours of each year.

Optimal Power Flow Model (OPF)

Several models are available in the industry to determine the optimal power flow of a system. Each power system includes points of injection (or generators) and points of withdrawal (users or loads). The transmission system includes transmission lines with each line having a fixed capacity limitation. However, these limits may vary with ambient conditions, allowing more power flow in cold or breezy weather. The Optimal Power Flow (OPF) model is used to determine, given a fixed infrastructure for electrical energy transmission, the amount of transfer that can occur between any injection point and any withdrawal point. The overall goal of the OPF is to identify dispatch and transmission flows that minimize costs without physically damaging the lines or equipment. In performing this analysis, the model takes several factors into consideration including losses on the lines or nodes within the grid, line impedances and reactive support devices, thermal constraints and voltage constraints.

Typically, the most prevalent use of an OPF model would be an Independent Service Operator (ISO) or a regulated utility's control area. Various regions throughout the United States market have established ISO's for determining the congestion and congestion rent within the transmission system. The New York ISO, the California ISO, the Electric Reliability Council of Texas (ERCOT), and the Pennsylvania-Jersey-Maryland (PJM) power pool are examples of regional ISOs. The various ISOs utilize their own techniques for determining congestion, strike prices, congestion rent and the like. Regardless of the technique used, the OPF model, if employed by an ISO, will provide a single snapshot picture of the electric transmission system. Typically, an ISO performs this function periodically and utilizes this information to establish congestion rent prices for the entire year or season. However, this technique only generates information based on today's static conditions. Further, during the year, considerable changes can occur such as injection points being added or removed, transmission lines being added or removed, and loads being added or removed. Thus, the strike prices and congestion rent values established at the beginning of the period may be totally irrelevant near the end of the period.

Therefore, there is a need in the art for a system that can produce accurate congestion information that anticipates regulatory changes which result in drastic changes in the power flow of the transmission system.

### SUMMARY OF THE INVENTION

The present invention is directed towards solving the aforementioned needs in the art, as well as other needs in the art, by providing an approach to provide modeling based on anticipated changes that will take place upon the enactment of new environmental regulations and changes to transmission infrastructure. The present invention is also designed to quantify the benefit of the transmission providers responding to congestion.

### BRIEF DESCRIPTION OF THE DRAWINGS

FIG. 1 is stack diagram illustrating how new environmental regulations may affect the retransmission of power the supply stack.

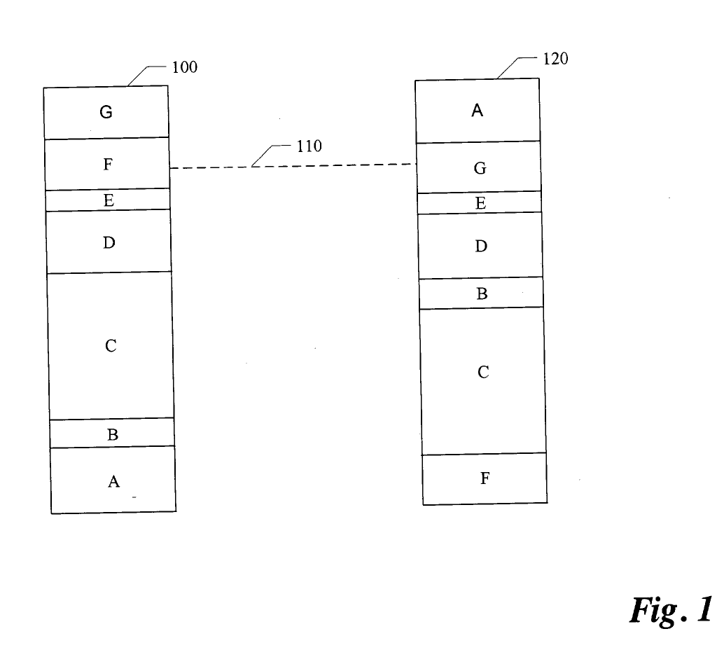

FIG. 2 is a conceptual diagram of a typical Optimum Generation Expansion Plan (OGEP).

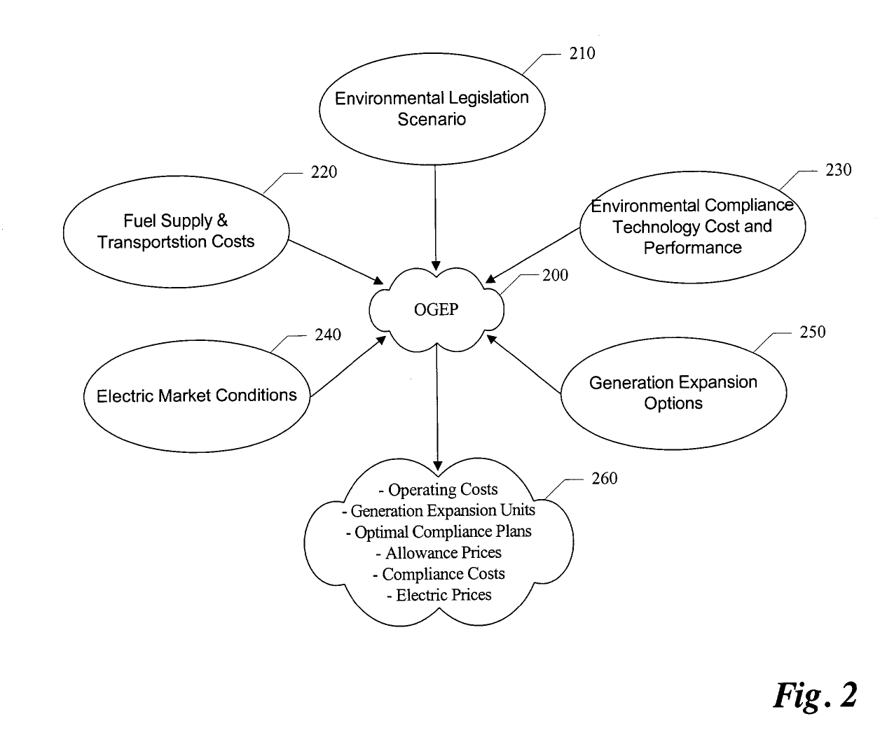

FIG. 3 is a block diagram illustrating an exemplary embodiment of the present invention.

FIG. 4 is a block diagram illustrating further details about the Electric System Optimization portion of the present invention.

### DETAILED DESCRIPTION

The present invention involves a new and novel method that combines scenarios and their probabilities to estimate the areas of possible congestion, the expected values of congestion contracts, locational marginal prices, and scenario specific generation and transmission expansion plans as well as other relevant outcomes. One embodiment of the present invention is a model that develops multiple generation and transmission scenarios. Another embodiment is a model that produces the optimum generation and transmission expansion plans based on each scenario. Yet another embodiment is a model that produces the expected values of the congestion contracts, locational marginal prices and other relevant outcomes. In general, this embodiment anticipates congestion within a grid based on multiple variations of economic growth, environmental legislation, multiple variations of generation and transmission infrastructure, deployment of emerging technology, the cost of environmental compliance technology and the supply and delivery of fuel. These models are performed through an iterative loop to find the most cost-effective solution considering all the scenarios and probabilities.

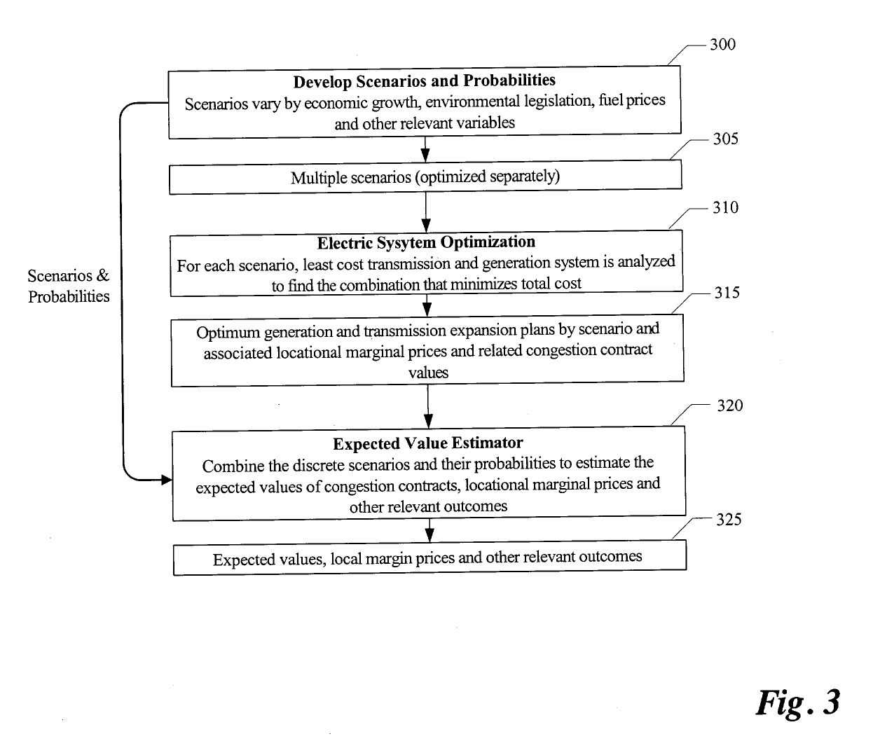

FIG. 3 is a block diagram illustrating an exemplary embodiment of the present invention. The illustrated exemplary embodiment includes a model to develop scenarios and probabilities 300, an Electric System Optimization model 310, and a model to estimate the expected output values 320. The Scenario and Probability Development model 300 builds scenarios that vary by economic growth, environmental legislation, fuel prices, and other relevant variables. A matrix of probabilities are developed using insight from the current and predicted market and environmental conditions. This model 300 will produce multiple scenarios 305 that will be optimized individually. The Electric System Optimization model 310 will analyze each scenario 305 for the least cost transmission and generation system in order to find the combination that minimizes total cost, maximizes profit and maximizes societal benefit. The Electric System Optimization model 310 output is the optimum generation and transmission expansion plans by each scenario, associated Locational Marginal Price (LMP) and related congestion contract values 315. The optimum generation and transmission plans show the most economic expansion plans. The LMP is defined as the marginal price for energy at the location where the energy is delivered or received. For accounting purposes, LMP is expressed in dollars per megawatt-hour ($/MWh). LMP is a pricing approach that addresses transmission system congestion costs, as well as energy costs. If no constraints are experienced on the transmission system during an hour, the LMP is equal to the cost or bid price of the highest increment of energy that is requested to operate during the hour. That is, there is one single clearing price or one that varies only by line losses. When there is transmission congestion, the dispatcher dispatches one or more of the generating units out of economic merit order to keep transmission flows within limits. There may be multiple large areas, each including many generating units that are dispatched to relieve the congestion. The LMP reflects the cost of re-dispatch for out-of-merit and cost of delivering energy to that location. If constraints are actually experienced on the transmission system during an hour, the congestion cost is the difference in LMP between the source and sink. Congestion contract values are the values that the Electric System Optimization model 310 expects the market to clear for the rights to deliver power from one node to another. These values are equal to the cost difference between the two nodes and they can be defined as an option or an obligation; that question is not decided yet in the market. A congestion contract value from node A to node B could be $5/MWh for the on-peak hours in July, which gives the owner the financial rights to the difference in location marginal prices between those points in excess of $5/MWh. This is an example of any option case. The Expected Value Estimator 320 combines the scenarios and probabilities 300 to estimate the expected values of the congestion contracts, LMPs, and other relevant outcomes 325.

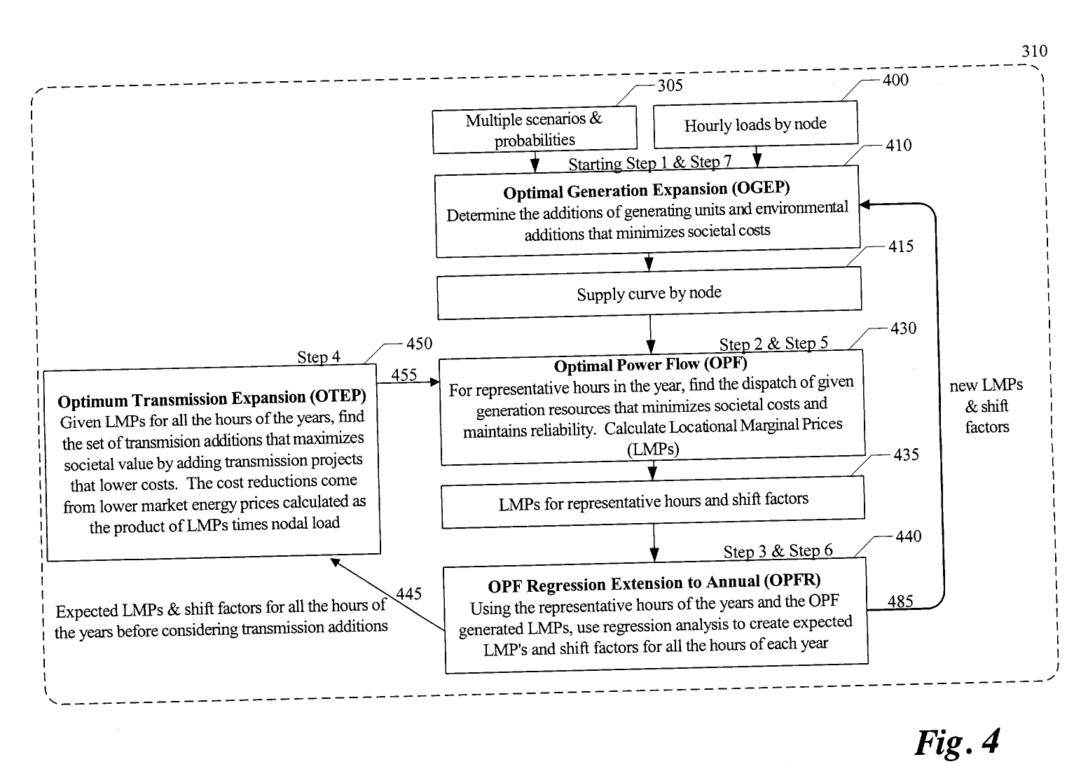

FIG. 4 is a block diagram illustrating further details of the Electric System Optimization model 310 of the present invention. The first step of the Electric System Optimization method 310 is the Optimum Generation Expansion Plan (OGEP) model 410 (Step 1). Each of the multiple scenarios 305 are optimized separately; the scenarios describe the various aspects associated with the cost of producing and delivering a commodity, such as electricity. These scenarios 305 include, but are not limited to, (a) environmental legislation scenarios to be simulated, (b) fuel supply, prices and transportation costs, (c) compliance technology cost and performance, (d) electric market conditions, and (e) generation and transmission expansion options.

The environmental legislation scenarios category of optimum expansion plan input parameters relate to the environmental legislation scenarios associated with the power source and the probability of the scenario coming to fruition. For instance, the parameters may include, but are not limited to, data representing an environmental legislation scenario, the current environmental policies that are imposed on the power source, and/or anticipated environmental polices.

The fuel supply and transportation cost input parameters include data that is representative of several factors, including but not limited to: the cost of fuel; the demand for various types of energy; the supply, including the cost of recovery and delivery, of various fuels such as coal and gas; the availability of various grades and types of fuel; and transportation and delivery logistics, problems and estimates related to the supply of fuel.

The compliance technology cost input parameters describe the existing technologies, and the known costs associated with them, for reducing emissions or otherwise meeting regulatory requirements. For instance, commercially available technology (i.e. filters and scrubbers) has known costs and effectiveness and can be parametrically represented. The electric market conditions production cost parameters focus on projected technology that may be introduced in the future and load growth scenarios.

The transmission expansion additions describe the additions, retirements, and enhancements to the transmission infrastructure. The changes in the transmission landscape significantly contribute to where congestion is likely to occur. Capturing these changes is important in creating a dynamic model.

It should be appreciated by those skilled in the art that the above-described input scenarios 305 are merely provided as examples and are in no way limiting on the scope of the present invention. The input parameters can vary greatly depending on the exact implementation of the Optimum Generation Expansion Plan (OGEP) model 410.

The OGEP 410 model provides information related to capacity additions that may be required. The capacity additions may include identifying generators that must be added, the types of generators that should be added or shut down, or simply those they need to reduce usage. In addition, OGEP 410 model may identify the dispatch order for generators at the power source. OGEP 410 model may also provide an estimate of the cost to produce electrical power and the prices of fuel used to create the electrical power. OGEP 410 model may predict the prices for allowances or emission credits that can be purchased by a power company, the level of emissions that can be expected from a specific configuration of dispatch ordering, and what retrofit decisions can be made (i.e., strap on technology) to help bring a power plant into compliance. Finally, OGEP 410 model may provide a least cost solution and total revenue requirement that comply with the multiple scenarios and probabilities 305 and hourly loads by node 400. In essence, the OGEP 410 model receives an array of scenarios and probabilities 305 as well as hourly loads by node 400 to create a supply curve 415.

The supply curve 415 describes the least cost configuration to operate a generation plant. The supply curve 415 is provided to the Optimal Power Flow (OPF) 430 model (Step 2). For representative hours, the OPF 430 model identifies the dispatch of given generation resources that minimize societal costs and maintains reliability. It also calculates LMPs associated with each generating unit and the point of injection or withdrawal for the particular transmission system. In addition, the OPF 430 model may identify the transmission capacities for each transmission line within the particular transmission system. The OPF 430 model identifies congestion within the transmission system, more particularly which transmission lines will be congested and the level of congestion for each of those transmission lines.

Within a particular transmission system, the number of points of injection and withdrawal may be quite significant. The OPF 430 model allows a snapshot view of a particular point of injection verses a particular point of withdrawal and the cost associated with delivering electrical power between them. The present invention allows a defined set of scenarios to be superimposed over various points of injection and withdrawal. For a given subset of points, the transmission outages or changes that may affect congestion, and what financial impact will be, can be modeled. In general, the present invention can generate a weighted analysis of the operation of the transmission system. The weighted analysis can be predicated on the probability of congestion, the cost associated with the delivery of electrical power between various points in the grid, the logistics and complexities associated with the delivery of electrical power between various points, or the like. Thus, in one scenario, it may be important to identify the financially significant impact that power outages or changes due to regulatory requirements may have. The present invention can be used to identify such effects. OPF 430 model produces the LMPs for representative hours and shift factors 435. A shift factor is a measure of the percent of power flow in transmission lines due to a generation injection in a node (substation) within the transmission system. For example let's consider a system which has 10 lines and three nodes (nodes x, y, and z). If a generator is connected to node x and is generating 1 MW of power then it can be calculated what percent of this one MW is flowing through each one of the ten lines in the system. Those percentages are called the shift factors. If all three nodes have generators attached to them then each line would have three shift factors indexed to the three nodes. Using the representative hours of the years and the OPF 430 model generated LMPs for representative hours and shift factors 435, the OPF Regression Extension to Annual (OPFR) 440 (Step 3) model uses regression analysis to create expected LMPs and shift factors 445 for all the hours of each year. The OPFR 440 model helps to alleviate running the OPF 430 model 8,760 times each year for each scenario. Further, in some markets, the hourly information for the entire year may not be available, thus, the OPFR 440 model helps to generalize the results provided by the OPF 430 model for hours throughout the year and in calculating the LMPs and loads for the hours that are not simulated by the OPF 430. Then, the LMPs and shift factors for all the hours of the years 445 are input into the Optimum Transmission Expansion (OTEP) 450 model (Step 4).

The OTEP 450 determines where it is economically justified to expand the transmission infrastructure based on the congestion data associated with the delivery of the product. Based on the LMPs and shift factors for all the hours of the years 445, the OTEP 450 determines the set of transmission addition that maximizes societal value by adding transmission projects that lower costs. The cost reductions come from lower market energy prices calculated as the product of LMPs times the nodal load. Taking into consideration that the optimum transmission expansion plan might change the generation plan, the processing of the model must be repeated until the addition or modifications to the transmission infrastructure is no longer economically justified. The additions to the transmission infrastructure 455 are then fed back into the OPF 430 model to determine new LMPs and shift factors based on the new transmission infrastructure 455 (Step 5). The processing of the OPFR 440 model is then repeated (Step 6). Then the new LMPs and shift factors for all the hours of the years 485 are input into the OGEP 410 (Step 7) to determine how the transmission addition will affect the generation infrastructure.

The Electric System Optimization 310 continues to loop until the LMPs stabilize, enhancements to the generation and transmission infrastructure are no longer justified, societal benefit is maximized, and maximum economy is realized.

It should be apparent to the reader that the present invention is unique in the industry and provides a revolutionary ability for generating congestion information for a non-static, dynamic system. In addition, as economic growth and environmental legislation invoke changes in the power flow of the electric transmission system, the present invention can provide congestion modeling based on anticipated changes that will take place upon the enactment of new environmental regulations and market design. The resultant transmission model generated by the present invention can be used to improve the cost effectiveness at which a power company can operate. It also optimizes the reliability of the transmission system. It also can use the invention to plan needed infrastructures enhancements or modification in their regions.

The examples herein have been provided for illustrative purposes only and should not be interpreted as restricting any aspects of the present invention. Alternate embodiments will become apparent to those skilled in the art to which the present invention pertains without departing from its spirit and scope. Accordingly, the scope of the present invention is described by the appended claims and supported by the foregoing description.

What is claimed is:

1. A method for generating a resultant model for a particular generation or transmission power system, the method comprising the steps of:
receiving scenario parameters related to the power system;
generating a plurality of scenarios and probabilities representing cost solutions for operating said power system given said scenario parameters;
optimizing each of said plurality of scenario for least cost solutions; and
generating the resultant model that identifies expected values within said power system based on the optimization step and that is associated with said scenarios and their probabilities.

2. The method of claim 1, wherein said scenario parameters comprise data representing economic growth.

3. The method of claim 1, wherein said scenario parameters comprise data representing environmental legislation.

4. The method of claim 1, wherein said scenario parameters comprise data representing fuel prices.

5. The method of claim 1, wherein said scenario parameters comprise data representing economic growth, environmental legislation and fuel prices.

6. The method of claim 1, wherein said optimizing step further comprises optimizing each of said plurality of scenario for minimizing total cost.

7. The method of claim 1, wherein said optimizing step further comprises optimizing each of said plurality of scenario for maximizing profit.

8. The method of claim 1, wherein said optimizing step further comprises optimizing each of said plurality of scenario for maximizing societal benefit.

9. The method of claim 1, wherein said optimizing step further comprises optimizing each of said plurality of scenario for minimizing total cost, maximizing profit and maximizing societal benefit.

10. The method of claim 1, further comprising the step of generating an optimum expansion plan based on the optimization step.

11. The method of claim 10, wherein said generating an optimum expansion plan comprises data that represents each scenario.

12. The method of claim 10, wherein said generating an optimum expansion plan comprises data that represents associated locational marginal prices.

13. The method of claim 10, wherein said generating an optimum expansion plan comprises data that represents related contract values.

14. The method of claim 10, wherein said generating an optimum expansion plan comprises data that represents each scenario, associated locational marginal prices and related contract values.

15. A system for generating a resultant model for a particular generation or transmission power system, the system comprising the components of:
a scenario and probabilities model, the scenario and probabilities model being operative to:
receive scenario parameters related to the power system, wherein said scenario parameters comprise data representing economic growth, environmental legislation and fuel prices; and
generate a plurality of scenarios and probabilities representing cost solutions for operating said power system given said scenario parameters;
an optimization model, the optimization model being operative to:
optimize each of said plurality of scenarios for minimizing total cost, maximizing profit and maximizing societal benefit; and
generate an optimized expansion plan by each of said plurality of scenarios, associated locational management price and related contract values; and
a value estimator model, the value estimator model being operative to:
generate the resultant model that identifies expected values within said power system based on the optimization step and that is associated with said scenarios and their probabilities.

16. The system of claim 15, wherein said scenario parameters comprise data of both a current and a predicted nature.

17. A system for generating a resultant model for a particular generation or transmission power system, the system comprising the components of:
a scenario and probabilities model, the scenario and probabilities model being operative to:
receive scenario parameters related to the power system, wherein said scenario parameters comprise data representing compliance technology, economic growth, environmental legislation, market conditions, fuel prices and transportation costs; and
generate a plurality of scenarios and probabilities representing cost solutions for operating said power system given said scenario parameters;
an optimization model, said optimization model comprising the components of:
an optimal generation expansion model, said optimal generation expansion model being operative to:
receive said plurality of scenarios and probabilities;
receive hourly loads related to said scenario parameters;
select a number of power units; and
generate a plurality of power curves describing a plurality of least cost configurations to operate said power system;
an optimal power flow model, said optimal power flow model being operative to:
identify a group of said plurality of curves, wherein said group is identified to minimize societal costs and maintain reliability; and
generate a plurality of locational marginal prices based on said group of said plurality of supply curves and associated with a power unit at a point of injection or withdrawal for a particular power system;
an optimal power flow regression extension model, said optimal power flow regression extension model being operative to:
create a plurality of expected locational marginal prices from said plurality of locational marginal prices and said hourly loads; and
create a plurality of shift factors from said plurality of locational marginal prices and said hourly loads; and
an optimum expansion model, said optimum expansion model being operative to:
determine power system infrastructure data based on data associated with the said expected locational marginal prices and said shift factors;
determine a set of power system additions to maximize societal value by said expected locational marginal prices and said shift factors;
feed said infrastructure data into said optimal power flow model, whereby said infrastructure data is used to determine a new plurality of locational marginal prices and a new plurality of shift factors; and
optimize power system based upon said new plurality of locational marginal prices; and
a value estimator model, the value estimator model being operative to:
generate the resultant model that identifies expected values within said power system based on the optimization model and that is associated with said scenarios and their probabilities.

18. The system of claim 17, wherein said optimal power flow regression extension model operation of creating a plurality of expected locational marginal prices from said plurality of locational marginal prices and said hourly loads, further comprises using regression analysis to create said expected locational marginal prices.
